(19) United States
(12) Patent Application Publication
(10) Pub. No.: US 2006/0071202 A1
(43) Pub. Date: Apr. 6, 2006

(54) Photosensitive paste composition

(76) Inventors: Beom-Wook Lee, Suwon-si (KR); Jong-Seo Choi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/222,338

(22) Filed: Sep. 8, 2005

(30) Foreign Application Priority Data
Sep. 9, 2004 (KR) 10-2004-0072090

(51) Int. Cl. H01B 1/22

(52) U.S. Cl. 252/514

(57) ABSTRACT

A photosensitive paste composition comprising conductive powders, an inorganic binder and an organic vehicle wherein the conductive powders comprise metal-coated powders is provided. According to the present embodiments, a photosensitive paste composition that has excellent properties such as excellent workability, anti-deterioration, high conductibility and anti-oxidation and an electrode pattern and green sheets can be prepared with low production cost.

### CROSS-REFERENCE TO RELATED PATENT APPLICATION

This application claims the benefit of Korean Patent Application No. 10-2004-0072090, filed on Sep. 9, 2004, in the Korean Intellectual Property Office, the disclosure of which is incorporated herein in its entirety by reference.

### BACKGROUND OF THE INVENTION

1. Field of the Invention

The present embodiments relate to a photosensitive paste composition, and more particularly, to a photosensitive paste composition which has properties such as excellent workability, anti-deterioration, high conductibility and anti-oxidation and from which an electrode pattern can be prepared with low production cost.

2. Description of the Related Art

Recently, various pattern-machining techniques have been developed with the increasing need for large, high density, high definition, highly reliable display devices. In addition, compositions for forming various microelectrodes that are compatible with such various pattern-machining techniques have been vigorously researched.

In order to form desired electrode pattern on a substrate surface of a display panel such as PDP, or an integrated circuit, in general, patterning methods using screen-printing has been used. However, patterns for high definition, large screens are difficult to obtain with this conventional screen-printing method since this method requires high proficiency and uses a screen with a low definition. Furthermore, the conventional screen-printing method leads to a short-circuit or disconnection during a printing process due to the use of the screen and limits the resolution. Therefore, it is limited to manufacture microelectrode patterns using the conventional screen-printing method.

Therefore, in recent years, photolithography using photosensitive paste has been developed to form a high definition electrode pattern suitable for large screens. This photolithography technique is a method of forming patterned electrodes by printing a photosensitive paste on the entire surface of a substrate, for example, a glass substrate, drying the substrate under predetermined conditions, exposing the substrate using an UV exposure apparatus with a photomask, developing to remove an uncured portion shielded by the photomask using a suitable developing solution, and firing the remaining cured layer at a predetermined temperature.

The photosensitive paste contains conductive powders, an inorganic binder such as glass frits, a copolymer binder, a photoinitiator, and a solvent, etc.

The conductive powder is a material for providing conductivity to electrodes. Silver, gold, copper, platinum, palladium, aluminum, an alloy thereof and the like can be used as such conductive powders. Among these, silver powders are widely used as conductive powders since silver powders have superior conductivity, can be easily processed into fine powders, are relatively advantageous in terms of cost, and deterioration such as oxidation does not occur upon firing.

Further, although copper powders are very cheap compared to other conductive materials and their conductivity is excellent, oxidation is very easily progressed thereby being deteriorated to copper oxides that cannot be used as a conductor. Accordingly, as a method of alleviating the oxidizing property of such copper powders, U.S. Pat. Nos. 4,652,465; 5,139,890; and 5,178,909 disclose a method of coating copper powders with silver or gold components, U.S. Pat. No. 6,610,417 discloses a method of coating copper powders with nickel, U.S. Pat. No. 6,652,990 discloses a method of coating copper powders with tin or zinc, U.S. Pat. Nos. 5,171,937 and 6,013,203 disclose an electronic wave masking material employing such copper powders coated with silver or gold, and U.S. Pat. No. 6,322,620 discloses a conductive ink.

Meanwhile, although nickel, aluminum, tungsten or molybdenum powders are more expensive than copper powders in terms of cost, they are advantageous since they are cheap compared to other noble metal conductive materials such as silver or gold. However, they cannot be used alone since oxidation is progressed on firing and their conductivity is low in light of silver or gold. Accordingly, as a method of overcoming the low conductivity for nickel powders, U.S. Pat. No. 5,855,820 discloses a method of preparing silver-coated nickel, etc. and an electronic wave masking material using the same, and U.S. Pat. No. 6,228,288 discloses the use of silver-coated nickel, etc. for a conductive device such as position sensor.

### SUMMARY OF THE INVENTION

The present embodiments provide a photosensitive paste composition which has very favorable properties such as excellent workability, anti-deterioration, high conductibility and anti-oxidation and from which an electrode pattern can be prepared with low production cost; an electrode prepared by employing the same and a method of preparing the electrode; and a green sheet prepared by employing the photosensitive paste composition and a method of preparing an electrode by employing the green sheet.

According to a present embodiment, there is provided a photosensitive paste composition comprising conductive powders, an inorganic binder and an organic vehicle characterized in that the conductive powders comprise metal-coated powders.

According to another embodiment, there is provided an electrode prepared by employing the photosensitive paste composition.

According to still another embodiment, there is provided a green sheet prepared by employing the photosensitive paste composition.

### DETAILED DESCRIPTION OF THE INVENTION

The present embodiments will now be described more fully hereinafter. These embodiments should not be construed as being limited to the examples set forth herein. Rather, these examples are provided to further supplement this disclosure.

The photosensitive paste composition according to some embodiments comprises conductive powders, an inorganic binder and an organic vehicle, wherein the conductive powders comprise metal-coated powders.

According to the present embodiments, the photosensitive paste composition has excellent properties such as excellent workability, anti-deterioration properties, high conductibility and anti-oxidation properties, and the electrode pattern can be prepared with low production cost.

The composition according to the present embodiments comprises metal-coated powders such as conductive powders.

The metal-coated powders may be copper, nickel, aluminium, tungsten or molybdenum powders coated with a metal.

Further, the metal used to coat the powders have excellent conductivity, coat easily onto the powder, and are not easily oxidized at ambient temperature or upon firing. The metals that satisfy such requirements may be for example, silver or gold.

Methods of preparing such copper, nickel, aluminium, tungsten or molybdenum powders coated with silver or gold include, but are not limited to, precipitation, doping, etc., which can be usually used in the art. The amount of the coating silver or gold may be about 0.5% to about 20% by weight. The metal-coated powders may be spherically shaped, such as spheres, in consideration of packing rate or UV transmitting property, etc., and their average particle diameter may be about 1.0 to about 10.0 μm.

The paste composition according to the present embodiments may comprise from about 0.1 to about 10 parts by weight of an inorganic binder and from about 20 to about 100 parts by weight of an organic vehicle, in relative amounts to about 100 parts by weight of the conductive powders.

Further, the composition according to the present embodiments may further comprise silver, gold or alloy powders thereof in addition to the metal-coated powders as additional conductive powders. The additional conductive powders to be added may be, for example, silver powders.

The apparent shape, specific surface area and average particle diameter of the additional conductive powders are the same as in the metal-coated powders, i.e., the apparent shape may be spherical, such as a sphere and the average particle diameter may be from about 1.0 to about 10.0 μm.

When such silver or gold powders are further used as additional conductive powders, their amount may be below about 50% by weight relative to the total weight of the composition. The composition according to the present embodiments further comprises an inorganic binder that plays a role in enhancing sintering property of the conductive powders during the firing process and providing adhesive force between a conductive film and a glass substrate. The amount of the inorganic binder may be from about 0.1 to about 10 parts by weight based on 100 parts by weight of the conductive powders.

The inorganic binder includes, but is not limited to, at least one selected from the group consisting of PbO—SiO₂ based binders, PbO—B₂O₃—SiO₂ based binders, ZnO—SiO₂ based binders, ZnO—B₂O₃—SiO₂ based binders, Bi₂O₃—SiO₂ based binders Bi₂O₃—SiO₂ based binders and PbO—SiO₂—B₂O₃—Al₂O₃ based binders. The apparent particle shape of the inorganic binder may be, but is not limited to spherically shaped, such as a sphere, and the average particle diameter may be about 0.1 to about 5.0 μm. Further, the softening temperature of the inorganic binder may be about 400 to about 600° C.

The composition according to one embodiment further comprises an organic vehicle. The amount of the organic vehicle may be about 20 to about 100 parts by weight based on 100 parts by weight of the conductive powders. The organic vehicle comprises at least one or more of each of the following components: an organic binder, a cross-linking agent, a photoinitiator, a solvent and other additives.

When an aqueous alkali solution is used as a developing solution during developing process, the organic binder comprises an organic monomer with one or more acidic groups. Such organic binders include various types of polymers, and an acryl-based resin among those is suitable in terms of cost and properties. To incorporate an acid group into the acryl-based resin, a monomer having a carboxyl group can be employed, and thus a copolymer of the monomer having a carboxyl group with at least one of other monomers can be used as an organic binder according to the present embodiments. The monomer having a carboxyl group may be, but is not limited to, at least one selected from the group consisting of acrylic acid, methacrylic acid, fumaric acid, maleic acid, vinyl acetic acid and anhydrides thereof. The other monomers copolymerized with the monomer having a carboxyl group may be at least one selected from the group consisting of methyl acrylate, methyl methacrylate, ethyl acrylate, ethyl methacrylate, n-butyl acrylate, n-butyl methacrylate, isobutyl acrylate, isobutyl methacrylate, 2-hydroxyethyl acrylate, 2-hydroxyethyl methacrylate, ethylene glycol monomethyl ether acrylate, ethylene glycol monomethyl ether methacrylate, styrene and p-hydroxystyrene.

Further, the organic binder may be composed of a one or more of the above organic monomers with one or more acidic groups cross-linked in a copolymer with an ethylenically unsaturated compound. The ethylenically unsaturated compound can be selected from the group consisting of glycidyl methacrylate, 3,4-epoxycyclohexylmethyl methacrylate and 3,4-epoxycyclohexylmethyl acrylate.

Furthermore, in the organic binder, the copolymers can be used alone, however, for the purpose of leveling a film or enhancing thixotrophy, at least one material selected from the group consisting of methyl cellulose, ethyl cellulose, nitrocellulose, hydroxymethyl cellulose, hydroxyethyl cellulose, hydroxypropyl cellulose, carboxymethyl cellulose, carboxyethyl cellulose and carboxyethylmethyl cellulose can be used in combination with the other components.

The organic vehicle may further comprise from about 20 to about 150 parts by weight of a cross-linking agent, from about 2 to about 75 parts by weight of a photoinitiator and from about 100 to about 500 parts by weight of a solvent, based on 100 parts by weight of the organic binder.

The amount of the organic binder to be used can be determined by the amount of the conductive powders, and the presence or absence and the amount of a sensitizer.

The cross-linking agent includes monofunctional and multifunctional monomers. The multifunctional monomers have superior exposing sensitivity and are a preferred group. Such multifunctional monomers include, but are not limited to, at least one monomer selected from the group consisting of diacrylates such as ethyleneglycol diacrylate (EGDA); triacrylates such as trimethylolpropane triacrylate (TMPTA), trimethylolpropane ethoxylate triacrylate (TMPEOTA), or pentaerythritol triacrylate (PETA); tetraacrylates, such as tetramethylolpropane tetraacrylate, or pentaerythritol tetraacrylate; and hexaacrylates such as dipentaerythritol hexaacrylate (DPHA). The amount of the cross-linking agent may be in a range from about 20 to about 150 parts by weight based on 100 parts by weight of the organic binder.

The photoinitiator plays a role in forming radicals by degradation on exposure to irradiating V, attacking the cross-linking agent with such radicals, and thus initiating the cross-linking reaction by the cross-linking agent. The photoinitiator can be at least one of, but is not limited to, benzophenone, o-benzoyl methylbenzoate, 4,4-bis(dimethylamine)benzophenone, 4,4-bis(diethylamino)benzophenone, 2,2-diethoxyacetophenone, 2,2-dimethoxy-2-phenyl-2-phenylacetophenone, 2-methyl-[4-(methylthio)phenyl]-2-morpholinopropane-1-one, 2-benzyl-2-dimethylamino-1-(4-morpholinophenyl)-1-butanone, bis(2,6-dimethoxybenzoyl)-2,4,4-trimethylpentylphosphine oxide, and bis(2,4,6-trimethylbenzoyl)phenylphosphine oxide. The amount of the photoinitiator may be in a range of from about 2 to about 75 parts by weight based on 100 parts by weight of the organic binder.

Any solvent that can dissolve the organic binder and the photoinitiator, is miscible with the cross-linking agent and other additives, and has a boiling point of about 150° C. or higher can be used. Examples of the solvents that satisfy the requirements include, but are not limited to, at least one selected from the group consisting of ethyl carbitol™ (diethylene glycol ethyl ether) (Dow Chemical Corporation, Midland, Mich.), diethylene glycol monobutyl ether, diethylene glycol monoethyl ether acetate, butyl carbitol™ acetate, texanol, terpine oil, dipropylenegylcol methyl ether, dipropyleneglycol ethyl ether, dipropyleneglycol monomethyl ether acetate, γ-butyrolactone, 2-ethoxyethanol acetate, butyl cellosolve™ (2-ethoxyethanol) (Dow Chemical, Midland, Mich.) acetate, and tripropyleneglycol. The amount of the solvent may be in a range from about 100 to about 500 parts by weight based on 100 parts by weight of the organic binder

In addition, the organic vehicle can further comprise additives, such as a sensitizer for enhancing sensitivity, a polymerization inhibitor and an anti-oxidizing agent for enhancing the preservability of the composition, a UV absorber for enhancing resolution, an anti-foaming agent for suppressing foaming in the composition, a dispersant for enhancing dispersibility, a leveling agent for enhancing the flatness of a printed layer, and a plasticizer for providing printability, etc. Those additives are optional, and one skilled in the art can determine if their use is warranted. Since those additives can function in increasing the dry film thickness, their minimum amount necessary for effectiveness may be used.

The photosensitive paste composition according to an embodiment can be prepared as follows. First, an organic vehicle is prepared by mixing an organic binder, a cross-linking agent, a photoinitiator, a solvent and other additives together and stirring the mixture. Subsequently, after placing an inorganic binder and the conductive powders according to the present embodiments into a mixer such as a planetary mixer (PLM) and stirring them, the organic vehicle prepared above is slowly added and mixed. The mixed paste is mechanically mixed by employing 3-roll mill. Then, particles having a large diameter and impurities such as dust, etc. are removed through filtering, and finally the foam in the paste is removed through a defoaming apparatus to prepare the photosensitive paste composition according to one embodiment

In another embodiment there is provided an electrode prepared by employing the photosensitive paste composition described above. The electrode is prepared through micro-pattern forming and firing processes. The photosensitive paste composition according to an embodiment can be used in patterning an electrode on a substrate for an integrated circuit (IC), a large scale integrated circuit (LSI) or a plasma display panel (PDP), etc. Hereinafter, the patterning will be described with reference to, for example, the plasma display panel.

The micro-pattern forming process involves: printing the photosensitive paste composition prepared as above on a surface of a substrate by employing a screen printer with a screen mask, such as SUS 325 mesh or SUS 400 mesh; drying the coated specimen at a temperature of about 80 to about 150° C. for about 5 to about 30 minutes in a convection oven or an IR oven; exposing the resulting paste coated layer with light from about 300 to about 450 nm by using a proper light source to form a micro-pattern; and developing the resulting micro-pattern with a suitable developing solution, such as solutions of Na₂CO₃, KOH, TMAH and the like, at a temperature of about 30° C. Further, the firing process is achieved by firing the resulting micro-pattern, for example, in an electrical furnace at a temperature from about 500 to about 600° C. for about 10 to about 30 minutes.

In still another embodiment, there is provided a green sheet prepared by employing the photosensitive paste composition. Herein, the green sheet refers to a structure in which dry paste is present between a support film and a protecting film.

The green sheet can be prepared through the following procedures. That is, a photosensitive conductive layer is formed by printing the photosensitive paste composition according to an embodiment on a support film, and then drying the paste by employing a drying apparatus. Finally, the green sheet can be prepared by laminating a protecting film onto a photosensitive conductive layer.

The green sheet prepared by the above method can be employed in preparing an electrode through the following procedures.

First, with stripping away the protecting film of the green sheet prepared as above by employing a laminator, the photosensitive conductive layer is attached to a substrate by employing a heating roller of the laminator. Then, the substrate is allowed to cool down to ambient temperature for a predetermined time. Subsequently, exposing was performed by employing a UV exposing apparatus attached to a photomask, the unexposed portion was developed by contacting it with a developing solution sprayed through a nozzle. The resulting product was fired by employing a firing furnace to obtain an electrode.

The present embodiments will be described in greater detail with reference to the following Examples. The following examples are for illustrative purposes and are not intended to limit the scope of the embodiments.

### EXAMPLES

### Example 1

### Preparation of a Photosensitive Paste Composition

A photosensitive paste composition according to the present embodiments was prepared by combining 70.0% by weight of Ag-coated Cu powders (spheres, average particle diameter of 2.5 μm), 3.0% by weight of a glass frit (amorphous, average particle diameter of 1.5 μm, PbO—SiO₂—B₂O₃—Al₂O₃ based), and 27.0% by weight of an organic vehicle (6.0% by weight of poly(MMA-co-MAA) having molecular weight of 15,000 g/mol, and acid value of 110 mg KOH/g as an organic binder, 6.0% by weight of trimethylolpropane triacrylate as a cross-linking agent, 2.5% by weight of bis(2,6-dimethoxybenzoyl)-2,4,4-trimethylpentylphosphine oxide as a photoinitiator and 12.5% by weight of a texanol as a solvent), stirring the mixture in a stirrer, and then kneading it with 3-roll mill. In preparing the composition, the organic vehicle was prepared first by combining the above organic binder, the photoinitiator, the cross-linking agent and the solvent, and then the glass frit material and Ag-coated Cu powders were added to yield the paste composition.

### Example 2

### Preparation of a Photosensitive Paste Composition

A photosensitive paste composition according to the present embodiments was prepared by combining 70.0% by weight of Au-coated Cu powders (spheres, average particle diameter of 6.5 μm), 3.0% by weight of a glass frit (the same as used in the example 1), and 27.0% by weight of an organic vehicle (the same as used in the example 1), stirring the mixture in a stirrer, and then kneading it with 3-roll mill. In preparing the composition, an organic vehicle was prepared first by combining the organic binder, the photoinitiator, the cross-linking agent and the solvent, then a glass frit and Au-coated Cu powders were added to yield the paste composition.

### Example 3

### Preparation of a Photosensitive Paste Composition

A photosensitive paste composition according to the present embodiments was prepared by combining 50.0% by weight of Ag-coated Ni powders (spheres, average particle diameter of 5.8 μm), 20.0% by weight of Ag powders (spheres, average particle diameter of 1.4 μm), 3.0% by weight of a glass frit (the same as used in the Example 1), and 27.0% by weight of an organic vehicle (the same as used in the Example 1), stirring the mixture in a stirrer, and then kneading it with 3-roll mill. In preparing the composition, the organic vehicle was prepared first by combining the organic binder, the photoinitiator, the cross-linking agent and the solvent, then the glass frit material, the and Ag-coated Ni powders and the Ag powders were added to yield the paste composition.

### Example 4

### Preparation of a Photosensitive Paste Composition

A photosensitive paste composition according to the present embodiments was prepared by combining 50.0% by weight of Ag-coated Al powders (spheres, average particle diameter of 4.3 μm), 20.0% by weight of Ag powders (the same as used in the example 3), 3.0% by weight of a glass frit (the same as used in the example 1), and 27.0% by weight of an organic vehicle (the same as used in the example 1), stirring the mixture in a stirrer, and then kneading it with 3-roll mill. In preparing the composition, the organic vehicle was prepared by first combining the organic binder, the photoinitiator, the cross-linking agent and the solvent, then the glass frit material, Ag-coated Al powders and Ag powders were added to yield the photosensitive paste composition.

### Preparation of an Electrode and Performance Evaluation Test

An electrode was prepared according to the process condition below by employing the photosensitive paste composition of the examples 1 to 3.
i) printing: screen printing was performed on a 20 cm×20 cm glass substrate.
ii) drying: performed at 100° C. in a drying oven for 15 minutes.
iii) exposing: irradiated with 500 mJ/cm² by employing an UV exposing apparatus mounted with high pressure Ag lamp.
iv) developing: 0.4% aqueous sodium carbonate solution was jetted with 1.5 kgf/cm² of the nozzle pressure.
v) firing: fired at 580° C. for 12 minutes with an electric firing furnace.

Dry film thickness, fired film thickness and resistivity (μΩ·cm) were measured for the electrodes prepared by above method, and the results are shown in Table 1 below.

TABLE 1

| Evaluation item | Example 1 | Example 2 | Example 3 | Example 4 |
|---|---|---|---|---|
| Dry film thickness (μm) | 7.2 | 6.5 | 6.9 | 7.0 |
| Fired film thickness (μm) | 4.5 | 4.0 | 4.2 | 4.3 |
| Resistivity (μΩ · cm) | 2.7 | 3.2 | 5.7 | 4.2 |

Dry film thickness and fired film thickness were measured using a μscan apparatus manufactured by Nanofocus (Oberhausen, Germany), and face resistance was measured by 4-probe method employing resistometer manufactured by HIOKI (Nagano, Japan) and then the resistance values were converted to resistivity values.

### Preparation of an Electrode by Using a Green Sheet and Performance Evaluation Test

Photosensitive paste compositions having component ratios shown in Table 2 below were prepared by using the same metal-coated powders as used in the Examples 1 to 4, and green sheets of Examples 5 to 8 were prepared by employing the same paste compositions.

TABLE 2

| Component | Example 5 | Example 6 | Example 7 | Example 8 |
|---|---|---|---|---|
| Ag-coated Cu powders | 75 | — | — | — |
| (the same as in the | | | | |
| Example 1) | | | | |
| Au-coated Cu powders | — | 75 | — | — |
| (the same as in the | | | | |
| Example 2) | | | | |
| Ag-coated Ni powders | — | — | 55 | — |
| (the same as in the | | | | |
| Example 3) | | | | |
| Ag-coated Al powders | — | — | — | 55 |
| (the same as in the | | | | |
| Example 4) | | | | |
| Ag powders | — | — | 20 | 20 |
| (the same as in the | | | | |
| Example 3) | | | | |
| Glass frit | 3 | 3 | 3 | 3 |
| Organic vehicle | 22 | 22 | 22 | 22 |

In the above Table 2, the component content are specified as % by weight.

The organic vehicle used in the above Examples are: 6.0% by weight of poly(MMA-co-MAA) having molecular weight of 15,000 g/mol, and acid value of 110 mg KOH/g as an organic binder, 6.0% by weight of trimethylolpropane triacrylate as a cross-linking agent, 2.5% by weight of bis(2,6-dimethoxybenzoyl)-2,4,4-trimethylpentylphosphine oxide as a photoinitiator and 7.5% by weight of a texanol as a solvent.

The green sheets were prepared by applying the photosensitive paste composition having the component ratios shown in the Table 2 onto a PET film having the thickness of 30 μm as a support film with a tablecoater, drying the paste composition at 100° C. for 20 minutes with an IR drying apparatus to form a photosensitive conductor layer, and laminating a PE film having the thickness of 20 μm as a protecting film onto the resulting photosensitive conductor layer.

An electrode was prepared according to the method described hereinafter by using the green sheets of the Examples 5 to 8. First, the photosensitive conductor layer was attached to PD200 glass substrate by employing a heating roller, while stripping the protecting film of the conductor dry film as described above by employing a laminator manufactured by GMP. After the laminating process, the substrate was allowed to stand for 30 minutes to lower the temperature to ambient temperature. Subsequently, the substrate was exposed to UV radiation at a level of 500 mJ/cm² by employing a parallel UV exposing attached with a photomask. The unexposed portion was developed by contacting it with 0.8% by weight of aqueous sodium carbonate sprayed through a nozzle at 30° C. The resulting product was fired at 580° C. for 20 minutes by employing a firing furnace to obtain an electrode.

Photosensitive conductor layer thickness, fired film thickness and resistivity (μΩ·cm) were measured for the electrodes prepared by the above method, and the results are shown in Table 3 below.

TABLE 3

| Evaluation item | Example 5 | Example 6 | Example 7 | Example 8 |
|---|---|---|---|---|
| Photosensitive conductor | 8.8 | 7.9 | 8.1 | 8.5 |
| layer thickness (μm) | | | | |
| fired film thickness (μm) | 4.9 | 4.5 | 4.6 | 4.9 |
| resistivity (μΩ · cm) | 2.6 | 3.3 | 6.2 | 3.9 |

The photosensitive conductor layer thickness and fired film thickness were measured using μscan manufactured by Nanofocus (Oberhausen, Germany), and face resistance was measured by 4-probe method employing a resistometer manufactured by HIOKI (Nagano, Japan) and then the values thus obtained were converted to resistivity values.

As can be found in the Examples 1 to 8, the photosensitive paste composition according to the present embodiments can replace the expensive conductive powders according to the prior art and also have excellent properties by using copper, nickel, aluminium, tungsten or molybdenum metal powders coated with silver or gold as conductive powders.

According to the present embodiments, a photosensitive paste composition which has excellent properties such as high levels of workability, anti-deterioration, conductibility and anti-oxidation and from which an electrode pattern can be prepared with low production cost is provided.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A photosensitive paste composition comprising conductive powders, an inorganic binder and an organic vehicle wherein the conductive powders comprise metal-coated powders.

2. The photosensitive paste composition according to claim 1, wherein the metal-coated powders are powders chosen from the group consisting of those in which copper, nickel, aluminum, tungsten and molybdenum powders are coated with a metal.

3. The photosensitive paste composition according to claim 1, wherein the metal is silver or gold.

4. The photosensitive paste composition according to claim 1, wherein the amount of the metal in the metal-coated powders is from about 0.5% to about 20% by weight.

5. The photosensitive paste composition according to claim 1, wherein the particle form of the metal-coated powders is spherically shaped.

6. The photosensitive paste composition according to claim 1, wherein the average particle diameter of the metal-coated powders is between about 1.0 to about 10.0 μm.

7. The photosensitive paste composition according to claim 1, wherein the photosensitive paste composition comprises from about 0.1 to about 10 parts by weight of an inorganic binder, and from about 20 to about 100 parts by weight of an organic vehicle, based on 100 parts by weight of the conductive powders.

8. The photosensitive paste composition according to claim 1, wherein the conductive powders further comprise powders of silver, gold or alloys thereof.

9. The photosensitive paste composition according to claim 8, wherein the particle form of the powders of silver, gold or alloys thereof is a sphere.

10. The photosensitive paste composition according to claim 8, wherein the average particle diameter of the powders of silver, gold or alloys thereof is from about 1.0 to about 10.0 μm.

11. The photosensitive paste composition according to claim 8, wherein the amount of the powders of silver, gold or alloys thereof is below about 50% by weight, based on the total weights of the photosensitive paste composition.

12. The photosensitive paste composition according to claim 1, wherein the inorganic binder is at least one selected from the group consisting of PbO—SiO₂ based, PbO—B₂O₃—SiO₂ based, ZnO—SiO₂ based, ZnO—B₂O₃—SiO₂ based, Bi₂O₃—SiO₂ based Bi₂O₃—B₂O₃—SiO₂ based binders and PbO—SiO₂—B₂O₃—Al₂O₃ based binders.

13. The photosensitive paste composition according to claim 1, wherein the inorganic binder has a softening temperature of from about 400 to about 600° C.

14. The photosensitive paste composition according to claim 1, wherein the average particle diameter of the inorganic binder is from about 1.0 to about 5.0 μm.

15. The photosensitive paste composition according to claim 1, wherein the organic vehicle comprises at least one or more of each of the following components: an organic binder, a cross-linking agent, a photoinitiator and a solvent.

16. The photosensitive paste composition according to claim 15, wherein the organic vehicle comprises from about 20 to about 150 parts by weight of a cross-linking agent, from about 2 to about 75 parts by weight of a photoinitiator and about 100 to about 500 parts by weight of a solvent, based on 100 parts by weight of the organic binder.

17. The photosensitive paste composition according to claim 15, wherein the organic binder is a copolymer of a monomer having a carboxyl group with at least one additional monomers.

18. The photosensitive paste composition according to claim 17, wherein the monomer having a carboxyl group is at least one selected from the group consisting of acrylic acid, methacrylic acid, fumaric acid, maleic acid, vinyl acetic acid and the anhydrides thereof.

19. The photosensitive paste composition according to claim 17, wherein the other monomers copolymerized with the monomer having a carboxyl group are at least one selected from the group consisting of methyl acrylate, methyl methacrylate, ethyl acrylate, ethyl methacrylate, n-butyl acrylate, n-butyl methacrylate, isobutyl acrylate, isobutyl methacrylate, 2-hydroxyethyl acrylate, 2-hydroxyethyl methacrylate, ethylene glycol monomethyl ether acrylate, ethylene glycol monomethyl ether methacrylate, styrene and p-hydroxystyrene.

20. The photosensitive paste composition according to claim 15, wherein the organic binder comprises a cross-linking group formed by the reaction of the monomer having a carboxyl group with an ethylenically unsaturated compound selected from the group consisting of glycidyl methacrylate, 3,4-epoxycyclohexylmethyl methacrylate and 3,4-epoxycyclohexylmethyl acrylate.

21. The photosensitive paste composition according to claim 15, wherein the cross-linking agent is at least one selected from the group consisting of diacrylates, triacrylates, tetraacrylates and hexaacrylates.

22. The photosensitive paste composition according to claim 15, wherein the photoinitiator is at least one selected from the group consisting of benzophenone, o-benzoyl methylbenzoate, 4,4-bis(dimethylamine)benzophenone, 4,4-bis(dimethylamino)benzophenone, 2,2-diethoxyacetophenone, 2,2-dimethoxy-2-phenyl-2-phenylacetophenone, 2-methyl-[-(methylthio)phenyl]-2-morpholinopropane-1-one, 2-benzyl-2-dimethylamino-1-(4-morpholinophenyl)-1-butanone, bis(2,6-dimethoxybenzoyl)-2,4,4-trimethylpentylphosphine oxide, and bis(2,4,6-trimethylbenzoyl)phenylphosphine oxide.

23. The photosensitive paste composition according to claim 15, wherein the solvent is at least one selected from the group consisting of ethyl diethylene glycol ethyl ether, butyl diethylene glycol ethyl ether, ethyl diethylene glycol ethyl ether acetate, butyl diethylene glycol ethyl ether acetate, texanol, terpine oil, dipropylene glycol methyl ether, dipropylene glycol ethyl ether, dipropylene glycol monomethyl ether acetate, γ-butyrolactone, 2-ethoxyethanol acetate, butyl 2-ethoxyethanol acetate and tripropylene glycol.

24. The photosensitive paste composition according to claim 15, wherein the organic vehicle further comprises at least one material selected from the group consisting of methyl cellulose, ethyl cellulose, nitrocellulose, hydroxymethyl cellulose, hydroxyethyl cellulose, hydroxypropyl cellulose, carboxymethyl cellulose, carboxyethyl cellulose and carboxyethylmethyl cellulose.

25. The photosensitive paste composition according to claim 15, wherein the organic vehicle further comprises at least one additive selected from the group consisting of a sensitizer, a polymerization inhibitor, an antioxidant, a UV absorbing agent, a defoamer, a dispersant, a leveling agent and a plasticizer.

26. An electrode prepared by employing the photosensitive paste composition according to claim 1.

27. A green sheet prepared by employing the photosensitive paste composition according to claim 1.
